(19) United States
(12) Patent Application Publication
(10) Pub. No.: US 2013/0290055 A1
(43) Pub. Date: Oct. 31, 2013

(54) SYSTEM AND METHOD FOR FACILITATING SCHEDULING OF EVENTS

(71) Applicants: Alon Konchitsky, Sunnyvale, CA (US); Rafi Shalom, Givatayim (IL)

(72) Inventors: Alon Konchitsky, Sunnyvale, CA (US); Rafi Shalom, Givatayim (IL)

(73) Assignee: Alon Konchitsky, Sunnyvale, CA (US)

(21) Appl. No.: 13/771,783

(22) Filed: Feb. 20, 2013

Related U.S. Application Data
(60) Provisional application No. 61/639,939, filed on Apr. 29, 2012.

(51) Int. Cl. G06Q 10/06

(52) U.S. Cl. CPC G06Q 10/06314
USPC 705/7.16; 705/7.13; 705/7.18

(57) ABSTRACT

Embodiments of the present invention provide a system and corresponding methods for facilitating scheduling of an event among plurality of users. The system may include various modules to received scheduling information corresponding to the event. The system may determine logical consequences corresponding to the schedule of the event based on predetermined plans of the users. The scheduling information may be shared among the plurality of users for enabling the users to update the scheduling information iteratively. The system may finalize the event automatically based on the updated scheduling information when each of the plurality of users approves the updated scheduling information. The system facilitates the scheduling of events with possibly limited resources by allowing incremental shared input from all participants and possibly by sharing their personal calendar information.

### TECHNICAL FIELD

The present invention relates in general to an application for managing the scheduling of events, such as those of meetings, conferences etc. for multi-centric participants and more particularly, the present invention relates to facilitating scheduling of events by finding an effective solution therefor.

### BACKGROUND OF THE INVENTION

Scheduling events, such as meetings, conferences, symposia, workshops etc. which typically involve multiple participants spread across widely in many places and regions is always a challenging task, especially when multitude of limitations such as the need to book a suitable venue, minimize the cost of traveling, ensuring the availability of key resources including the participation of important members, faculty, senior management or other dignitaries.

The task becomes further complicated when it is required to take into account the limitations and preferences of many people with regard to a variety of possible dates and venues. Currently these tasks are accomplished verbally or by sharing calendars of the expected participants where ever possible. For example, ‘ics’ file format is mainly used by calendar application vendors such as Apple (iCal), Google (Google Calendar), and Microsoft (Outlook) for allowing users to share calendars, such as through E-mails. Further, a protocol such as CAP (Calendar Access Protocol) may be used intra-organization by users for collaborative calendar sharing.

However, such verbal and written communications are quite tedious, time-consuming and inefficient. Further, sharing full calendars exposes too much irrelevant information without providing the specific information about participants' preference for specific dates and venues. Also, in the existing systems, a participant (such as an inviter) needs to analyze full shared calendar of other participants to determine available suitable dates for each participant. This involves not only tedious but also a significantly time consuming task of determining and resolving clashes between preferred dates and pre-decided schedules of other participants.

In today's business environment, meetings often pull together a number of people from multiple national or even international locations. The choice of venue often depends on which people plan to attend in person and the remainder is connected virtually through teleconference, video conference, web conference, etc. if available. These factors again require careful consideration of budgets, available tools and other cost-saving measures such bulk booking or promotional fares available for flying to a given location.

There are quite a few commercially available meeting planning tools into existence, such as those provided by Microsoft Outlook, Lotus Notes etc., which are linked to calendars and diaries through the users' tool-bar. These applications are capable of interlinking calendars of multiple users when required and help working out plausible options for meetings taking into account the available time slots in individual calendars. While most of these applications have embraced further sophistication such as mobile application and several other options in their recent versions, yet these are inadequate to take into consideration all the issues described above when planning a meeting.

Further, the value of any available tool is determined by how people use it. One of the essential requirements of a tool like Microsoft Outlook Meeting Planner is that all participants for a meeting should have access to Outlook and must be using the Calendar feature as a matter of routine. This is more often not the case in reality. Thus, the required tool must necessarily be free from constraints.

There are other problems too with available meeting planning tools. One of the key features included in such meeting planning tools involves triggering a volley of emails to possible participants proposing a scheduled meeting with possible venue. While respondents tend to provide variety of responses adding to complexity, the non-respondents simply make everything uncertain and difficult. Alternative way of initiating such a dialogue is through physically verifying individual calendars, which is no less cumbersome and difficult.

Further, existing art such as U.S. Pat. No. 5,050,077 along with its continuation U.S. Pat. No. 5,197,000 provides a best compromise of a desired time for scheduling a meeting among terminal users who are provided with calendaring applications and who may not all be available at desired time for an earlier proposed meeting. The system automatically takes into account the non-availability of the prospective attendees and works out a best fit as an alternative schedule with permissible relaxations with regard to their availability.

Similarly, U.S. Pat. No. 5,615,121 discloses a scheduling system for fulfilling a series of service requests with regard to amount of resources a task requires as per requested services within the available time slot for the event using combinatorial optimization model. The solution is said to be particularly useful in scheduling service calls for technicians in utility industry such as telecommunication. Further, US20060010023 provides a system and tool for organizing meetings by sharing of information with an ultimate aim of reporting on financial and technical aspects of the meeting for business advantage.

Based on the aforementioned, a method and a system for facilitating scheduling of events are required to overcome existing challenges and to provide an effective solution in real time. The system and corresponding method should be able to handle multiple parameters, constraints and relevant aspects of a meeting or a similar event including the direct and indirect costs to work out the effective solution for each given situation. Thus, the system and the method should be able to provide cost and time effective solution for assisting participants in scheduling events.

### SUMMARY

In an embodiment of the present invention, a method for facilitating scheduling of an event for a plurality of users is provided. The method may include receiving scheduling information corresponding to the event. The scheduling information may be received from a user, of the plurality of users, capable of initiating a schedule of the event. Further, the method may include determining one or more logical consequences corresponding to the schedule of the event based on a list of predetermine plans of at least one user of the plurality of users. The method further includes enabling each of the plurality of users to update the scheduling information iteratively based on at least one of the logical consequences and preferences. The updated scheduling information may be made viewable to each of the plurality of users. Furthermore, the method may include finalizing the event automatically based on the updated scheduling information when each of the plurality of users approves the updated scheduling information.

In another embodiment of the present invention, a scheduling system is provided for facilitating scheduling of an event for a plurality of users. The scheduling system may include a receiving module configured to receive scheduling information from a user of the plurality of users for initiating a schedule of the event. Further, the scheduling system may include an analysis module configured to analyze predetermine plans of each of the plurality of users to determine one or more logical consequences corresponding to the schedule of the event. Herein, the plurality of users may be enabled to update the scheduling information iteratively based on at least one of the logical consequences and one or more preferences thereof. Furthermore, the system may include an event finalizing module configured to finalize the event based on the updated scheduling information when each of the plurality of users provides approval for the updated scheduling information.

In yet another embodiment of the present invention, another method is provided for facilitating scheduling of an event for a plurality of participants. The method may include enabling a user of a plurality of users to initiate a schedule of the event by sharing scheduling information with each of the plurality of users. Further, the method may include enabling each of the plurality of users to update the scheduling information iteratively based on preferences thereof and predetermined plans of each of the plurality of users. The updated scheduling information displayed to each of plurality of users. Herein, the updated scheduling information is utilized for finalizing the event when each of the plurality of users provides an approval for the updated scheduling information.

In another embodiment, the present invention provides a decision making tool that may facilitate the scheduling of an event that has multiple participants. Specifically this means that relevant information about the scheduling of a specific event (such as relevant information from calendars of all participants, known general preferences of participants, approval and disapproval of participants regarding specific dates and venues, the availability of specific venues, and so forth) is to be concentrated in a way such that all participants are able to review it and may receive information about its immediate logical consequences regarding a variety of possible dates and venues for the specific event. Moreover, any participant viewing this data may be allowed to make changes in his/her input that may affect the gathered information and its consequences, which is again accessible to all expected participants of the event.

Further another embodiment of the present invention may provide a machine that might be a personal computer or other device of each expected participant of an upcoming event. The machine may allow all participants to consider many possibilities for possible dates and venues of the event, and add their preferences, limitations, and approvals or disapprovals for each of them. The machine may also allow using the data from the personal calendars of participants, or calendars created to keep track of the availability of specific venues, in order to exclude impossible options, and rate various options according to their feasibility. Each participant (user) may be allowed for sharing of all relevant information about multiple options, so it is possible to schedule the event quickly and in the best possible way according to the preferences and limitations of the expected participants. The machine may be, without limitation, an independent system, device or apparatus that may be utilized by each expected participant. In another embodiment, the system may be implement on a server (such as a server of a company for the use of its employees), also as a plug-in to a calendar method or apparatus, instant messaging method or to other social media machine, or an integral part of a calendar or social media method or apparatus.

### BRIEF DESCRIPTION OF THE DRAWINGS

Having thus described the invention in general terms, reference will now be made to the accompanying drawings, which are not necessarily drawn to scale, and wherein

FIG. 1 illustrates an exemplary environment where various embodiments of the present invention are implemented;

FIG. 2 illustrates an exemplary protocol for bilateral event scheduling, in accordance with an embodiment of the present invention;

FIGS. 3 and 4 illustrate block diagrams of a system for scheduling events for a plurality of participants, in accordance with an embodiment of the invention;

FIG. 5 illustrates a database for storing information corresponding to each participant for utilizing by the system in facilitating scheduling of an event, in accordance with an embodiment of the present invention; and

FIG. 6 illustrates a flow diagram of a method for facilitating scheduling of an event, in accordance with an embodiment of the invention.

### DETAILED DESCRIPTION

The present invention provides a system and methods for facilitating scheduling of an event for a plurality of participants (hereinafter may terchangeably be referred to as ‘users’). In an embodiment, each of the plurality of participants is connected through network, such as social media such as Facebook, Linkedln and other public/private networks such as blogs, discussion forum etc. The present invention utilizes such information along with personal information, professional information, calendar information and web diaries corresponding to each user to determine preferences and availability of each user for an event.

The proposed system, in its most preferred embodiment, may be a web based system for scheduling of events in which members of a user community participate as per an agreed time schedule at a venue that are both commonly suitable to all or a majority of members. The essential pre-requisite for such a system to work smoothly and efficiently are the underlying databases containing information about the users (members), their availability on specific time schedules as per their calendar and diary information, possible venues with all desired characteristics for the event.

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

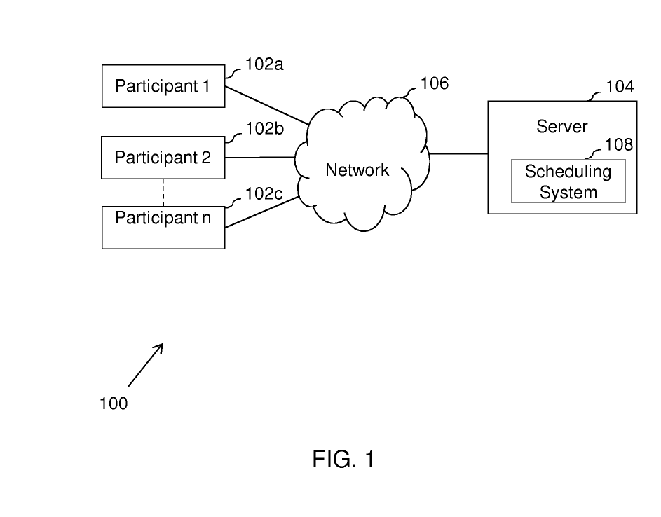

FIG. 1 illustrates an exemplary environment 100 where various embodiments of the present invention are implemented. Further, FIG. 1 illustrates that one or more participants, such as a participant 1 102a, participant 2 102b, up till a participant n 102n, may be communicably connected to a server 104 through a network 106 for implementing a scheduling system 108. Each participant utilizes a device for connecting to the server 104 through the network 106. Such device may include, but is not restricted to, a personal computer, a laptop, a mobile phone, a smart-phone or any other device capable of data communication. Examples of the network 106 may include any wired or wireless network, such as but not limited to, a Local Area Network (LAN), a Wide Area Network (WAN), a Wi-Fi network and so forth.

Further, in an embodiment, the scheduling system 108 (hereinafter may interchangeably be referred to as ‘system 108’) may be utilized as a plug-in to each device of a participant for scheduling the event among the participants associated with the devices. The users (such as the participant 1 102a, participant 2 102b, . . . , and participant n 102n) may be required to register with the system 108 by providing their personal and professional information to the system 108. Further, the users may provide links to their web accounts and calendars that may be utilized by the system 108 to access pre-scheduled information such as date, time, venue and so forth corresponding to prescheduled tasks of the users. In an embodiment, the system 108 may analyze public or private network (such as blogs, discussion forum, social network such as Facebook etc. and the like) of each user for analyzing information to determine friends, preferences and pre-scheduled events corresponding to each user. Further, in an embodiment, the server 104 may have a memory (not shown) for storing such information corresponding to each user. In another embodiment, the system 108 may have its own memory for storing such information after accessing from different web links.

Further, the system 108 may extract information corresponding to each user and his/her friends' network from the corresponding device that the user may utilize to access the system 108. For example, the system 108 may be utilized as a plug-in to a user device (that may be utilized by a user for implementing the system 108) that may extract contact information from the device to determine prospective participants for the event to be scheduled. Further, each user may be enabled to initiate a request for scheduling the event for a plurality of prospective participants. The user who initiates the request may or may not be a prospective participant of the plurality of participants for the event. The user may provide scheduling information while initiating a schedule for the event. The scheduling information may include relevant information about the scheduling of a specific event such as, but is not limited to, available dates, venues, calendar information, and information corresponding to prospective participants of the event.

The scheduling information may be shared with the plurality of prospective users (who receive request for the event) for enabling the plurality of users to approve or disapprove the initiated schedule of the event based on their preferences and/or prescheduled events that may be occurring clashingly on a same date and/or at a same venue as defined by the scheduling information. Further, in an embodiment, the system 108 may upgrade the scheduling information in the memory (not shown) once the schedule (for the event) is initiated by a user and shared with other users (participants). For example, the system 108 may add information regarding approvals and disapprovals that may be received from other participants.

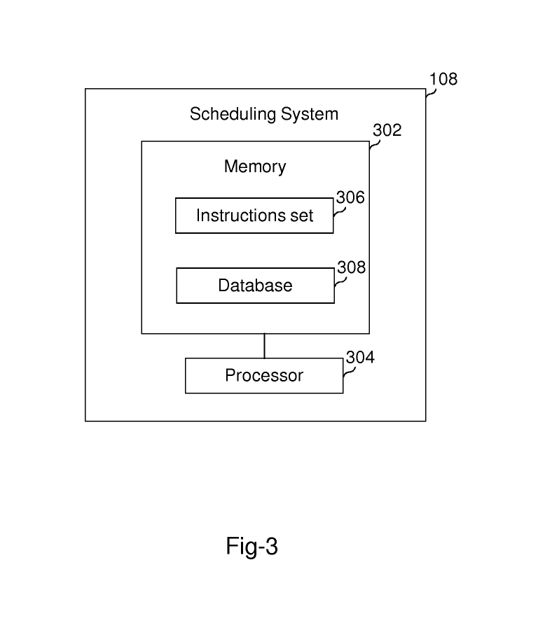

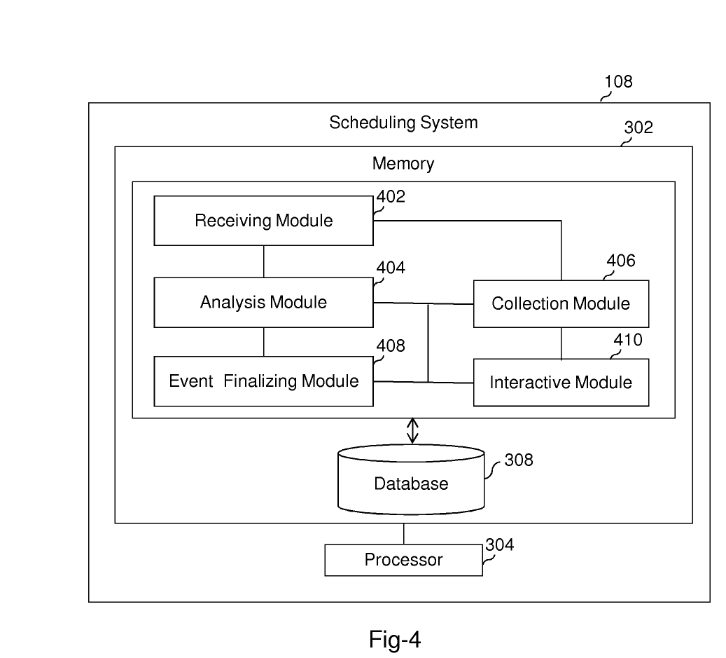

Further, the plurality of users may be enabled to update the scheduling information by adding one or more available venues, one or more calendars' information, approval, disapproval for the initiated schedule of the event and the like. The system 108 may be implemented to determine one or more logical consequences corresponding to the schedule of the event based on the scheduling information and calendars' information that may be shared by the plurality of users. In an embodiment, the logical consequences may depict a conflict between the preferences of the plurality of users for the schedule of the event. Such conflict between the preferences (of the plurality of users) may be determined by the system 108 based on analysis of the calendars' information associated with the plurality of users. The implementation of the system 108 is described further in conjunction with FIGS. 3 and 4.

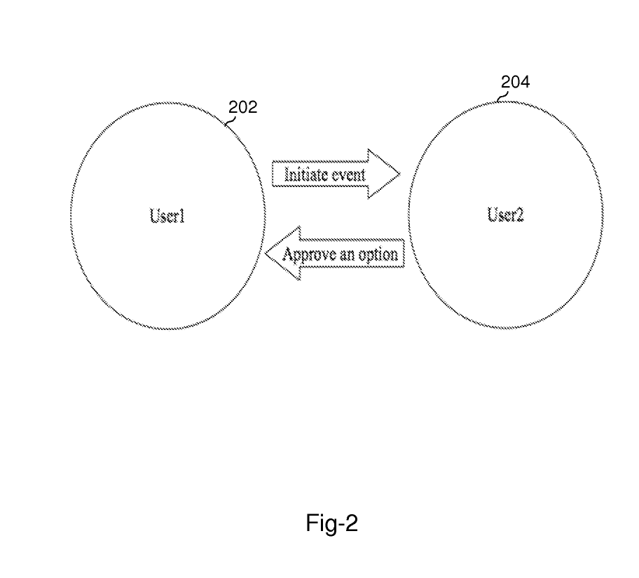

Referring now to FIG. 2 that illustrates an exemplary protocol for bilateral event scheduling, in accordance with an embodiment of the present invention. The present invention includes, but is not limited to, establishing interaction among a plurality of users and facilitating the users for scheduling an event. Specifically, FIG. 2 depicts interaction between two participants (users) that may be connected through a network (not shown) for scheduling an event by utilizing a system, such as the scheduling system 108. As shown, user 1 202 may initiate a possible event by sharing scheduling information for the event with the system and other user(s), such as the user 2 204. The scheduling information may include, but is not limited to, requirements for scheduling the event. For example, the scheduling information may include, but is not limited to, an expected time the event would require to occur, a span of dates that may be considered, the relevant hours of the day (for example evening hours), the difference in time from the beginning and ending of other events on the personal calendar that reflects the assumed time that would be needed to move between locations of adjacent events, etc.).

The user1 202 may or may not wish to get a report of the impact of the information in the calendars of himself/herself and of User2. In an embodiment, the system may analyze the calendars of both the users (user 1 and user 2) to determine a result/logical consequence of the scheduling information of the event. The result may be a prioritized list of scheduling possibilities. User1 202 may still add possible venues, and acknowledge or reject some of the options, before sending the event initiation request to User2 204. This communication is described by the “initiate event” arrow. Accordingly, the user2 204 may provide acknowledgement of the request by approving or disapproving the scheduling information for the event.

Further, the user 2 204 may provide various options for available dates and venues for changing the scheduling of the event. The event may be finalized when the user 2 approves the scheduling information (provided by the user 1 202) based on his/her preferences and pre-determined scheduled. This communication is described by the “approve an option” arrow. Once the user 2 204 approves the scheduling information, the calendars of both users may be automatically updated with the approved scheduling information for the event. Further, the system may send a notification to the users (user 1 and user 2) for the finalized event. In an embodiment, the user 1 202 and the user 2 204 may be enabled to define setting for changing their calendars. For example, if any of the users (user 1 202 and user 2 204) is not willing to allow changes in his/her calendar then the user(s) may define the settings accordingly and thereby the system may provide just notification without updating the calendars of the user 1 202 and the user 2 204.

Further, the system may allow each of the users to update the scheduling information until both the users approves the scheduling information. For example, User2 204 may update the scheduling information with his/her own preferences that may be notified to the user 1 202 for freezing the event. This process of updating modification may be repeated iteratively until User1 or User2 accept a possible date and venue. Further, the system may provide notification regarding the change in the scheduling information to both of the users. Also, the system may analyze the calendars of both the users to determine logical consequences of making change in the scheduling information. It may be appreciated by a person skilled in the art that the system may note changes in the personal calendar of any user due to any other event and accordingly may modify the logical consequences that may be presented to the user.

Further, it may be appreciated by a person skilled in the art that the system may be implemented for more than two users in the similar way for facilitating in scheduling an event. In such cases, a user may send an event initiation request to all other users of a plurality of users. In an embodiment, a user may send an initiation request (for scheduling an event) by creating an ad-hoc list of people from his/her list of friends, or by using an already established user group. The user who initiates the request may add possible venues prior to sending the request. For example one of the venues added by the user may be a conference room with its own calendar information.

Based on the request corresponding to scheduling information of an event, each of the plurality of users may add their preferences, approvals, disapprovals, and so forth. Each addition by any of the users affects a list of possibilities for the event, a number of approvals for each possible date, time and venue for the event. Accordingly, the system may update the list of possibilities for the event based on preferences (approvals/disapprovals) of the users and their calendars' information. This list and all added information may be accessible by all participants.

Once all users approve the scheduling information such as a date, and possibly a venue as well, for the event, the event may be finalized and calendars may be updated automatically. In an embodiment, if there is no agreement then the system may determine one or more obstructing plans from pre-determined plans mentioned in the calendars of the users. The obstructing plans may be defined as the pre-determined plans that hinders/prevents scheduling of the event from finalizing. For example, if all, except one user, of the plurality of users are agreed for a scheduling information of an event but due to pre-determined conflicting schedule of the one user, the scheduling of the event is difficult to be finalized then the pre-determined plan of the one user may be considered by the system as the obstructing plan. The system may request such user(s) having obstructing plan(s) to modify their calendars to adjust the obstructing plans in some way to make the time and venue available according to the scheduling information of the event. In an embodiment, the system may suggest the user(s) for adjusting the obstructing plan in an effective way for making availability of the user(s) for the event.

Thus, the system may indicate a way for some of the users to change their personal calendar so an agreement can be achieved, or to relax some of the demands that prevented an agreement (for example, allowing a larger time span for possible dates for the event). Changes in the general setup of the event such as the time span in which it could be held may be limited to User1, or allowed to all participants, depending on prior preferences made for the decision process. In case no agreement is made, the information about the preferences of all users may remain easily accessible, thus it may still facilitate the scheduling of the event by other means.

In an embodiment, the user 2 204 may reject the event initiation request if the user 2 204 does not wish to participate in the event initiated by the user 1 202. For example, if a user (initiator) initiates an event scheduling request for socializing with one or more users (of the Facebook) who may not be known contacts of the user (initiator) then one or all of the users may reject the request if they are not willing to participate in the event for which the request is initiated by the user (initiator).

Referring to FIGS. 3 and 4 illustrating block diagrams of a system, such as the scheduling system 108, for scheduling events for a plurality of participants, in accordance with an embodiment of the invention. As shown in FIGS. 3 and 4, the scheduling system 108 (hereinafter may be referred to as ‘system 108’) may include a memory 302 communicably coupled a processor 304. Further, as shown in FIG. 3, the memory 302 may include instructions set 306 and a database 308. The instructions set may include plurality of executable instructions for performing one or more tasks when executed by the processor. Such one or more tasks may be performed by various components/modules of the system 108 when the corresponding instructions are executed by the processor 304.

As shown in FIG. 4, the instructions set may be implemented through various modules when executed by the processor. Specifically, as shown in FIG. 4, the system 108 may include, but is not limited to, a receiving module 402, an analysis module 404, a collection module 406, an event finalizing module 408 and an interactive module 410. Each module of the system 108 may be communicable coupled to other modules of the system 108 for proper communication among the modules and thus implementation of the system 108 to facilitate scheduling of an event.

The receiving module 402 may be configured to receive scheduling information from a user (of a plurality of prospective users) capable of initiating a schedule of the event. Herein, the plurality of users may be prospective participants who receive the request for scheduling the event. In an embodiment, the user may be a participant who initiates scheduling of the event based on his/her preferences. In another embodiment, the user may not be a participant but just a scheduler who initiates scheduling of the event by sending request on behalf of one of the plurality of participants.

The user may need to be first registered with the system 108 for initiating the request for scheduling the event. In an embodiment, the user may provide information such as, but is not limited to, personal information, professional information, and other information such as calendar information, links to social media and information corresponding to friends while registering with the system 108. The system 108 may store the information received from the user in the database 308. Once the user is registered, the user may send the scheduling information corresponding to the event to the system 108 that may be received by the receiving module 402. The scheduling information may include, but is not limited to, available dates, times venues for event, venues' details such as contact details, capacity and special features of each venue, calendar information of the user and the like.

Further, the user may send his/her preferences for each venue from the available venues. In an embodiment, the user may send just one venue and date in the scheduling information for the event. Accordingly, the system 108 may consider one approval for the venue and date provided as the scheduling information. The system 108 may record, in the database 308, a number of approvals and a number of disapprovals (from one or more users of the plurality of users) for the scheduling information separately for various options (such as various options for venues, dates, and time) of the event.

Furthermore, the initiated scheduling information may be shared with each of the plurality of users when the user initiates the request for scheduling the event. Also, the users may be enabled to add one or more options corresponding to various available venues, dates etc., in the scheduling information. Further, on sharing of the scheduling information with the plurality of users, each of the plurality of users may be enabled to acknowledge the receipt of the scheduling information and also to share personal calendars with the system 108 for scheduling of the event based on the calendars to prevent conflict in the initiated event and prescheduled tasks (that may be mentioned in the calendars of the users).

Further, the analysis module 404 may analyze predetermined plans of each of the plurality of users to determine one or more logical consequences due to scheduling information of the event. The predetermined plans may be accessed from calendars of each of the users. Further, the collection module 406 may be utilized for gathering the predetermined plans of each of the plurality of users from at least one of personal calendars of the users, web diaries of the users, web based discussion forum corresponding to the users. Further, the system 108 may utilize links (URLs) for accessing public or private network of each of the user to determine preferences of the users, pre-scheduled tasks of the users, dates and venues those are already booked or under planning to be booked for other tasks. Further, the predetermined plans may be gathered to keep track of at least one of availability and practicability of one or more options corresponding to a plurality of venues for scheduling the event. Such links may either be provided by each user while registering with the system 108 or after receiving the scheduling information for the event.

The analysis module 404 may analyze the gathered information corresponding to the predetermined plans of each of the users to determine an obstructing plan from the analyzed predetermined plans. Herein, the obstructing plan may be referred to a plan that is prescheduled and prevents an agreement between each of the plurality of users for the scheduling information corresponding to the event. In an embodiment, the logical consequences determined by the analysis module 404 may include the information corresponding to such obstructing plans, variety of possible dates and venues for the event to be finalized and the like. Further, the determined logical consequences including the obstructing plans may be provided to each of the plurality of users by an interactive module 410.

Further, based on the logical consequences and personal preferences, each user may provide response for the shared scheduling information to schedule the event suitably. In an embodiment, each user may be enabled to send response to the shared scheduling information by approving or disapproving the scheduling information. Further, the plurality of users may be enabled to update the scheduling information based on the logical consequences and their personal preferences. The updated scheduling information may be viewable by each of the plurality of users to send their approval or disapproval therefor. If the updated scheduling information is conflicting with preferences of any user then the user may disapprove the updated scheduling information or may further modify the updated scheduling information. Based on the modification in the updated scheduling information, analysis module 404 may determine updated logical consequences for the modified scheduling information. Thus, each user may modify the scheduling information or add various options for the scheduling information anytime. Accordingly, the analysis module 404 may determine corresponding logical consequences and various available options based on the newly added options for the event.

Thus, the process of providing various possible options (based on the calendars or changes in information regarding venues that may be gathered from various online social media) and logical consequences corresponding to the scheduling information of the event, the users may be enabled to update the scheduling information iteratively based on users' preferences.

In an embodiment, if any predetermined (prescheduled) obstructing plan(s) is (are) required to be changed for receiving the agreement from the users for the event then the interactive module 410 may notify the corresponding user (having obstructing plan mentioned in his/her personal calendar) for modifying his/her personal calendar for modifying the predetermined obstructing plan that is preventing the agreement between the users. In another embodiment, the event finalizing module 408 may finalize the event based on the latest scheduling information when each of the plurality of users provides approval for the updated scheduling information. Accordingly, the system 108 may update calendars of each for the plurality of users with the finalized scheduling information for the event.

The interactive module 410 may notify the finalized event to each of the plurality of users. Further, the interactive module 410 may the update the calendars of each user with the finalized scheduling information of the event. In an embodiment, the system 108 may provide alerts to each user at a preset time before the scheduled event for reminding the users regarding the scheduled event.

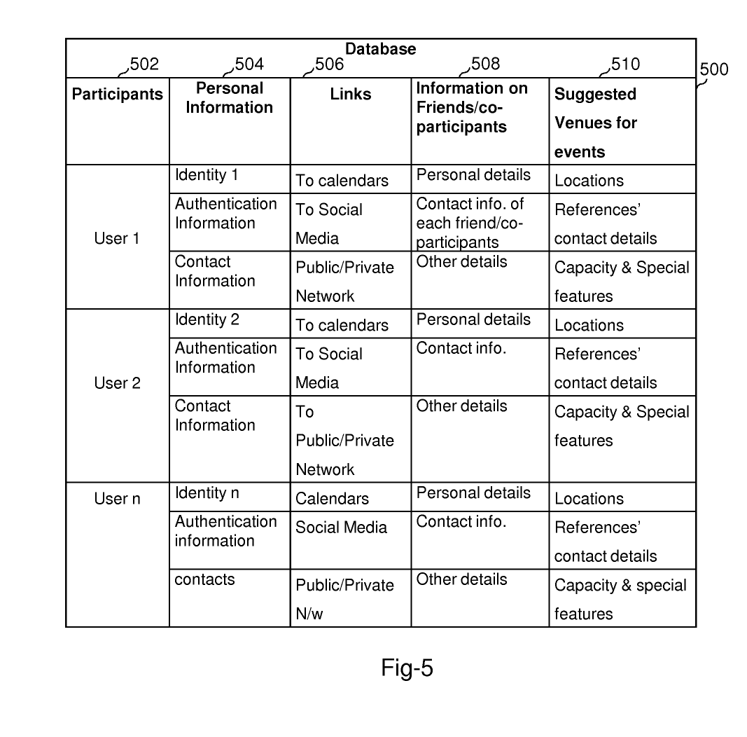

The system 108 may store the finalized scheduling information of the event in the database 308. Further the database 308 may store all versions of the scheduled information and determined logical consequences in the database. In an embodiment, the analysis module 404 may utilize such stored history of the previous scheduling of the events for providing an effective solution to assist users in finalizing any event. The database 308 is described in detail further in conjunction with FIG. 5.

FIG. 5 illustrates a database 500 for storing information corresponding to each participant for utilizing by a system, such as the scheduling system 108, in facilitating scheduling of an event, in accordance with an embodiment of the present invention. The database 500 may include profiles of users and general information corresponding to scheduling of an event. The users may register with their username, and subscribe required personal information for allowing the system to link to their personal calendars and diaries residing in their own web-enabled systems compatible with protocols that may utilized by the system. Alternatively, users may input required information about their availability or non-availability manually when prompted to do so. A format and protocol for holding the information on user profiles and related data may follow common standards like WebDAV or CaIDAV or other similar standard.

As shown, column 502 of the database 500 depicts number of registered users (participants), such as user 1, user 2 and so on up to user n corresponding to any prospective event. Further, the database may store personal information (as depicted by column 504) corresponding to each user. For example, the personal information corresponding to the user 1 may include, but is not limited to, identity 1, authentication information and contact information. The identity, such as identity 1 may include an identity such as name, code for the user 1 that may be unique for each user registered with the system, such as the scheduling system 108.

Further, the authentication information may include, but is not limited to, user name and password that may be generated for each user, such as user 1, at the time of registration of the user 1 with the system. The authentication information may be different for each user that may be utilized by the user to access the system for scheduling of an event. Similarly, the contact information may include, but is not limited to, postal address, an E-mail ID and a phone number. Similarly, for other users (such as user 2, . . . up till user n), the personal information may be stored in the database 500. Additionally, the database 500 may store professional information such as organization, expertise, position in the organization and the like.

Further, the database 500 may include, but is not limited to, links to other sources (shown by column 506), information on friends/co-participants (shown by column 508), and suggested venues for events (shown by column 510). The links may include URLs that may be utilized by the system to access calendars, web diaries, social media (such as Facebook, Linkedln etc.), public/private networks (such as discussion forum, blogs etc.) for accessing information corresponding to prescheduled tasks/events corresponding to the users. Further, the information corresponding to friends or co-participants may include, but is not limited to, contact information and other information such as calendar information of the friend.

Furthermore, the information corresponding to venues of the events that may be suggested by a user may be stored with the user's profile. Further, in an embodiment, user data may be extracted from existing social networks. User names, groups, and venues may also be created automatically on local networks. For example, a company may create user accounts, groups, venues (such as conference rooms), and calendars on a local company server. Such information corresponding to venue (hereinafter may be referred to as ‘venue information’) may include, but is not limited to, location, contact information of the reference of venues, capacity and other features of the suggested venues. The information corresponding to venues may be utilized by the system in analyzing each venue with respect to number and profiles of the participants and accordingly the system may provide logical consequence of selecting any particular venue from the available venues. Additionally, in an embodiment, the system may provide one or more alternatives for the venue that may be suitable according to preferences of the users. For example, if a possible place for an event is a restaurant then the system may suggest one or more restaurants to the users according to details such as known locations of the users, food preferences, and limitations (such as far restaurant) of the users. Further, for an instance, if a user is a vegetarian and prefers Mexican food then the system may determine a suitable restaurant according to the user's preference and available seating facility for a number of users at a particular time for an event. Such details corresponding to the users' preferences may be determined by the system through one or more online social profiles, web diaries associated with the users.

Further the information stored in the database is not limited to the above described information. The database 500 may further store scheduling information such as date, venue, number of participants, number of approvals and disapprovals from the participants corresponding to the event. Further, the system may store intermediate updates corresponding to the scheduling information that may be performed by participants while finalizing scheduling information for an event. Such updates in the scheduling information may be utilized by the system for future scheduling of the events.

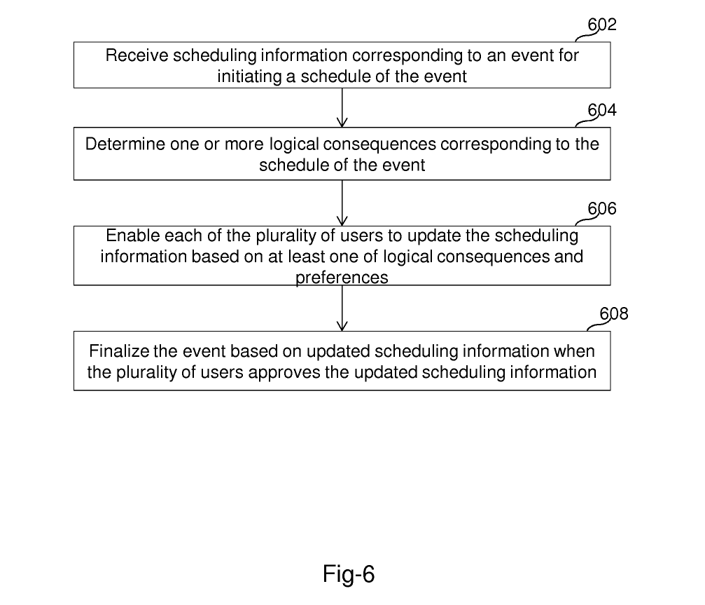

Referring now to FIG. 6 illustrates a flow diagram of a method for facilitating scheduling of an event, in accordance with an embodiment of the invention. The event may be scheduled for a plurality of users as described previously in conjunction with FIGS. 1 to 5. The order in which the method is performed is not intended to be construed as limitation, and further any number of the method steps may be combined in order to implement the method or an alternative method without departing from the scope of the invention.

At step 602, scheduling information corresponding to an event may be received for initiating an event. Each user may be enabled to initiate a schedule of the event by sharing the scheduling information with each of the plurality of users. Further, at step 604, the received information may be analyzed (by a system, such as the system 108) to determine one or more logical consequences corresponding to the schedule of the event based on a list of predetermined plans of at least one user of the plurality of users. The predetermined plans may be gathered from at least one of personal calendars, web diaries, and web based discussion forum corresponding to the plurality of users. The logical information may be displayed to each of the plurality of users.

In an embodiment, determining the logical consequences corresponding to the schedule of the event may include determination of obstructing plans (predetermined plans) based on the analysis of the predetermined plans and the scheduling information. The obstructing plan may include prescheduled plans that may prevent agreement among the plurality of users for the scheduling information corresponding to the event.

In an embodiment, the users may approve the scheduling information when the scheduling information is not conflicting with any of the predefined schedules of the users. In another embodiment, the users may disapprove the scheduling information based on the logical consequences and preferences of the users. In this embodiment, further, at step 606, the method may enable each of the plurality of users to update the scheduling information based on at least one of the logical consequences and preferences of users. Such updated scheduling information may be viewable by each of the users. Also, the users may add one or more additional options of available venues for scheduling the event. Based on the updated scheduling information, the logical consequences may be updated that may then be provided to the users. Further, based on the logical consequences of the updated scheduling information, any user may approve or disapprove the updated scheduling information. Thus, the users may be enabled to update the scheduling information iteratively until all the users approve the scheduling information.

At step 608, when each of the plurality of users approves the scheduling information (or updated scheduling information), the event may be finalized corresponding to the approved scheduling information. The finalized event may be communicated to the users and accordingly calendars of each user may be updated. In an embodiment, if any of the users disapproves the scheduling information then a specific user having one or more obstructing plans may be notified to modify the obstructing plan for finalizing the event.

Further, the method described here above for facilitating a plurality of users to schedule an event is not limited to the steps as shown in FIG. 6. Further many other steps may be implemented to provide an effective solution to each user in real time. It may be appreciated by a person skilled in the art that the event oriented community may be populated through linking to social networking websites, web based discussion forum and the like from the users' end.

Further, the method steps may be understood in light of the descriptions for the embodiments provided previously in conjunction with FIGS. 1 to 5. Accordingly, various embodiments explained previously in conjunction with FIGS. 1 to 5 may be implemented as steps or embodiments of the method described in FIG. 6. Further, the invention is not limited to above-mentioned embodiments and examples and many other embodiments and examples may be implemented in light of the invention without departing from the scope of the invention. Also, the usage of terminology such as ‘first’, ‘second’, ‘third’ and ‘subsequent’ should not be considered as restrictive aspect of the present invention as such terminologies are used just for the purpose of better explanation.

Further, those skilled in the art will appreciate that the term such as ‘Scheduling Assistant’ or ‘scheduling tool’ utilized here above may also be described as “meeting scheduler”, “scheduler”, “meeting planner', ‘event scheduler’ etc. Further, ‘user’, ‘user-group’ or ‘user-community’ may be referred to a participant or participants in the proposed event / meeting.

Advantageously, the present invention discloses a system and corresponding methods for facilitating scheduling of events. In broad embodiment, the present invention provides a decision making tool that may facilitate the scheduling of events, by allowing all expected participants to share up to date knowledge about the limitation, preferences, and acknowledgements with other expected participants, and by keeping all participants informed immediately about limitations on possible venues and other required resources for the event.

Further, advantageously, the present invention makes all the information about availability, preferences, and approval/disapproval of all expected participants of an event exposed to each participant (user) at once, thus avoiding the need to communicate the information between the participants, making all participants aware of all the relevant information at all times, and simplifying the process of event scheduling.

Further, the present invention allows incremental additions of information from all participants, and immediate sharing of that information, to ensure that each participant has a clear picture about the feasibility of various dates and locations for the event.

The system may utilize data from personal calendars of participants, calendars of conference rooms etc. without the need for the participants to allow changes in their personal calendars, or even the need to expose them to other participants. The participants may be required just to allow the system to use their calendar information in order to facilitate the scheduling of an event.

The system and corresponding methods may consider many possible dates and venues at the same time while sharing preferences, limitations, and approvals of all participants.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general purpose computers, special purpose computers, or other programmable data processing translator to produce machines, such that the instructions that execute on the computers or other programmable data processing translator create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims. The invention has been described in the general context of computing devices, phone and computer-executable instructions, such as program modules, being executed by a computer. Generally, program modules include routines, programs, characters, components, data structures, etc., that perform particular tasks or implement particular abstract data types. A person skilled in the art will appreciate that the invention may be practiced with other computer system configurations, including hand-held devices, multiprocessor systems, microprocessor-based or programmable consumer electronics, network PCs, minicomputers, mainframe computers, and the like. Further, the invention may also be practiced in distributed computing worlds where tasks are performed by remote processing devices that are linked through a communications network. In a distributed computing world, program modules may be located in both local and remote memory storage devices.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for facilitating scheduling of an event for a plurality of users comprising:
receiving scheduling information corresponding to the event, the scheduling information received from a user, of the plurality of users, capable of initiating a schedule of the event;
determining one or more logical consequences corresponding to the schedule of the event based on a list of predetermine plans of at least one user of the plurality of users;
enabling each of the plurality of users to update the scheduling information iteratively based on at least one of the logical consequences and preferences, the updated scheduling information viewable to each of the plurality of users; and
finalizing the event automatically based on the updated scheduling information when each of the plurality of users approves the updated scheduling information.

2. The method of claim 1 further comprising displaying the logical consequences to each of the plurality of the users, wherein the logical consequences change on updating the scheduling information.

3. The method of claim 1, wherein the predetermine plans are gathered from at least one of personal calendars, web diaries, and web based discussion forum corresponding to the plurality of users.

4. The method of claim 1, wherein initiating the schedule of the event comprising sharing the scheduling information with each of the plurality of users.

5. The method of claim 1 further comprising:
analyzing predetermine plans of each of the plurality of users;
determining an obstructing plan from the analyzed predetermine plans, the obstructing plan prevents an agreement between each of the plurality of users for the scheduling information corresponding to the event; and
notifying a user, having the obstructing plan, to modify a personal calendar thereof for modifying the predetermine plan preventing the agreement.

6. The method of claim 1, wherein the event is finalized by automatically updating calendars of each of the plurality of users.

7. The method of claim 1 further comprising enabling each of the plurality of users to update the scheduling information by adding one or more available dates, venues, calendar information, approval and disapproval corresponding to the dates and venues of event.

8. The method of claim 1, wherein the predetermine plans are gathered to keep track of at least one of availability and practicability of one or more options corresponding to a plurality of venues for scheduling the event.

9. A scheduling system for facilitating scheduling of an event for a plurality of users comprising:
a receiving module configured to receive scheduling information from a user of the plurality of users for initiating a schedule of the event;
an analysis module configured to analyze predetermine plans of each of the plurality of users to determine one or more logical consequences corresponding to the schedule of the event, wherein the plurality of users are enabled to update the scheduling information iteratively based on at least one of the logical consequences and one or more preferences thereof; and
an event finalizing module configured to finalize the event based on the updated scheduling information when each of the plurality of users provides approval for the updated scheduling information.

10. The scheduling system of claim 9 further comprising an interactive module for providing the one or more logical consequences to each of the plurality of users.

11. The scheduling system of claim 9 further comprising a collection module for gathering predetermined plans from at least one of personal calendars, web diaries, and web based discussion forum corresponding to the plurality of users.

12. The scheduling system of claim 9, wherein the analysis module further configured to determine an obstructing plan from the analyzed predetermined plans, the obstructing plan prevents agreement among the plurality of users for the scheduling information corresponding to the event.

13. The scheduling system of claim 9 further comprising an interactive module to:
notify the finalized event to each of the plurality of users; and
notify a user to modify a personal calendar thereof for modifying a predetermined plan preventing the agreement.

14. The scheduling system of claim 9, wherein each of the plurality of users updates the scheduling information by adding one or more available venues, calendar information, approval and disapproval corresponding to the dates and venues of event.

15. The scheduling system of claim 9 further comprising a database for storing personal information of the plurality of users, one or more links to personal calendars corresponding to the plurality of users, updated scheduling information, available venues for the event and information corresponding to one or more friends.

16. A method for facilitating scheduling of an event for a plurality of participants, the method comprising:
enabling a user of a plurality of users to initiate a schedule of the event by sharing scheduling information with each of the plurality of users;
enabling each of the plurality of users to update the scheduling information iteratively based on preferences thereof and predetermined plans of each of the plurality of users, the updated scheduling information displayed to each of plurality of users; and
finalizing the event based on the updated scheduling information when each of the plurality of users provides an approval for the updated scheduling information.

17. The method of claim 16 further comprising sharing the predetermined plans of each user with the plurality of users.

18. The method of claim 16 further comprising determining one or more logical consequences corresponding to the schedule of the event based on the predetermine plans of at least one user of the plurality of users, the logical consequences provided to each of the plurality of users.

19. The method of claim 16, wherein the scheduling information is updated by adding at least one of preferences, approval, disapproval for the initiated schedule of the event.

20. The method of claim 16, wherein the predetermine plans are gathered from at least one of personal calendars, web diaries, and web based discussion forum corresponding to each of the plurality of users.
